(19) United States
(12) Patent Application Publication
(10) Pub. No.: US 2025/0034852 A1
(43) Pub. Date: Jan. 30, 2025

(54) SEALING DEVICE HAVING POSITIVE AND NEGATIVE PRESSURE RESISTANT WATER SEAL PROTECTION FUNCTION

(71) Applicant: Chengxu JIANG, Shenyang, Liaoning (CN)

(72) Inventor: Chengxu Jiang, Shenyang, Liaoning (CN)

(21) Appl. No.: 18/709,262

(22) PCT Filed: Jun. 6, 2023
(86) PCT No.: PCT/CN2023/098460

§ 371 Date: May 10, 2024

(30) Foreign Application Priority Data
Jul. 21, 2022 (CN) 202210856940.5

(51) Int. Cl. E03C 1/294; E03C 1/298

(52) U.S. Cl. CPC E03C 1/294; E03C 1/298

(57) ABSTRACT

A sealing device having a positive and negative pressure resistant water seal protection function. The sealing device comprises a sleeve body; an opening and closing valve plate is rotatably connected to the lower end of the sleeve body; a negative pressure valve mechanism is arranged at a side portion of the sleeve body; the negative pressure valve mechanism comprises a groove body and a multifunctional cover; the groove body is of a bevel structure; a pressure conduction film is provided on the bevel of the groove body facing the inner side of the sleeve body; a pressure conduction body corresponding to the pressure conduction film is arranged in the groove body; a push rod of the pressure conduction body passes through the multifunctional cover in a connection fit with the groove body; the push rod works in conjunction with the opening and closing valve plate by means of a locking mechanism; and the multifunctional cover is provided with a gas pressure hole communicated with a sewer line. The sealing device can prevent negative pressure from damaging water seal.

### FIELD OF THE INVENTION

The present application relates to sewer line water seal protection. More specifically, the present application relates to a sealing device having positive and negative pressure resistant water seal protection function.

### BACKGROUD

Sewer lines are pipes used to carry wastewater and sewage from buildings and support public facilities in cities. To prevent sewage and harmful gases from overflowing in the sewer pipelines, anti-odor devices are installed. Sewer pipelines anti-odor devices rely on water seals to isolate the used space from the sewer pipeline, preventing harmful gases from overflowing.

The pressure in a sewer pipeline can change with the drainage conditions. When negative pressure forms in the pipeline, it can suck the water in the water seal and damage it. This can cause the sewer pipeline to connect to the used space. As a result, harmful gases will enter the used space from the sewer pipe, damaging the indoor environment and affecting people's health.

### SUMMARY

In various embodiments, a sealing device having positive and negative pressure resistant water seal protection function that can solve the shortcomings of the above technology, is provided.

To solve the above technical problems, the sealing device having positive and negative pressure resistant water seal protection function comprising a sleeve; the lower end of the sleeve is rotatably connected with an Open-close valve plate, comprising a negative pressure valve is provided on the side of the sleeve; the negative pressure valve including a groove and a multi-functional cover; the structure of the groove is beveld; a pressure conducting membrane is provided on the inclined surface of the groove, facing the inner side of the groove; the groove is provided with a pressure conductor corresponding to the pressure conducting membrane; the push rod of the pressure conductor passes through the multifunctional cover which is matched with the groove; the push rod cooperates with the open-close valve plate through a locking mechanism; the multifunctional cover is provided with a pressure hole connected to the drain line.

In an embodiment, the surface of the opening of the groove is inclined and arranged in the sleeve; wherein the upper end of the opening surface of the groove is located at the upper port edge of the sleeve; wherein the lower end of the opening surface of the groove is located in the middle of the lower port of the sleeve; the upper port of the sleeve is an intake; wherein the area enclosed by the surface lower end of the opening of the groove and the lower port of the sleeve is the drain outlet.

Wherein the lower end surface of the sleeve is provided with a sealing ring that matches the upper surface of the open-close valve plate.

Wherein a repulsion core set and an attraction magnetic core set are provided between the bottom of the groove, multifunctional cover and the open-close valve plate; wherein when the open-close valve plate rotates to the open position, the repulsion core set approaches and generates repulsive force, and the attraction magnetic core set moves away; when the Open-close valve plate rotates to the closed position, the attraction magnetic core set generates an attractive force while the repulsion core set moves away.

Wherein both sides of the open-close valve plate connect to the sleeve via the shaft; wherein the attraction magnetic core set is located on the side of the shaft which is close to the drain outlet; wherein the magnetic core set is arranged on the side of the shaft opposite the drain outlet.

In another embodiment, a pressure-bearing plate is placed at the opening of the groove facing towards the inner side of the sleeve; a gap is provided between the pressure-bearing plate and the pressure conducting membrane to connect the internal space of the sleeve.

In a third embodiment, a mutually repelling magnets are positioned between the pressure conducting membrane and the pressure conductor.

Wherein the pressure conductor is provided with a magnetic block; wherein magnetic points are dispersedly provided on the pressure conducting membrane.

In a fourth embodiment, a locking mechanism including a vertical movement rod; the upper end of the vertical movement rod cooperates with the push rod of the pressure conductor through the bevel; the end of the open-close valve plate is provided with a lock; the lock and the vertical movement rod cooperate through the arc surface.

### Beneficial Effects of the Invention:

1. When there is a negative pressure in the sewer pipeline, a pressure conducting membrane gets elastically deformed due to the pressure difference on both sides. The pressure conduction film is deformed and displaced in the direction of the pressure conductor, thereby reducing the distance between the magnetic point on the pressure conduction film and the magnetic block on the pressure conductor. The force of mutual repulsion between the conductors increases, causing displacement in the groove. When the push rod of the pressure conductor is activated, it triggers the locking mechanism, which then locks the Open-close valve plate. This prevents the negative pressure in the sewer pipeline from opening the valve plate, thus avoiding any damage to the water seal connected to the pipeline. Consequently, this also prevents harmful gases from entering the room through the sewer pipes.

2. A pressure-bearing plate protects the pressure conducting membrane of the present invention to avoid the impact of water flow on the Negative pressure valve when entering the water. Also, it reduces the force of water flow energy on the pressure conducting membrane.

3. The groove opening surface in the current invention is beveld and positioned within the sleeve. This arrangement tilts the entire Negative pressure valve, creating additional water flow space within the sleeve, ultimately enhancing the drainage capacity.

4. The current invention enhances the sensitivity of the pressure conductor by placing magnetic points on the pressure conducting membrane. The magnetic forces of the magnetic points and magnetic blocks repel each other. This allows the pressure conductor to be displaced even when the negative pressure is very low. This ensures that the locking mechanism can lock the Open-close valve plate effectively, safeguarding the water seal in the sewer pipeline. Additionally, the dispersed magnetic points do not hinder the flexibility of the pressure transmission membrane. This ensures that the pressure transmission membrane can deform under the influence of negative pressure without causing damage to the pressure conductor pressing action.

5. The present locking mechanism boasts a compact and reasonable structure, which efficiently transmits motion within a small space to ensure that the valve plate does not open when there is negative pressure in the sewer pipeline. Simultaneously, when the locking mechanism is subjected to water flow pressure, it can open the valve plate by overcoming the resistance. This allows for smooth drainage by opening and closing the valve plate as needed.

### BRIEF DESCRIPTION OF THE DRAWINGS

FIG.1 is an internal structure view of a sealing device having positive and negative pressure resistant water seal protection function; and

FIG.2 is a perspective view of a sealing device having positive and negative pressure resistant water seal protection function.

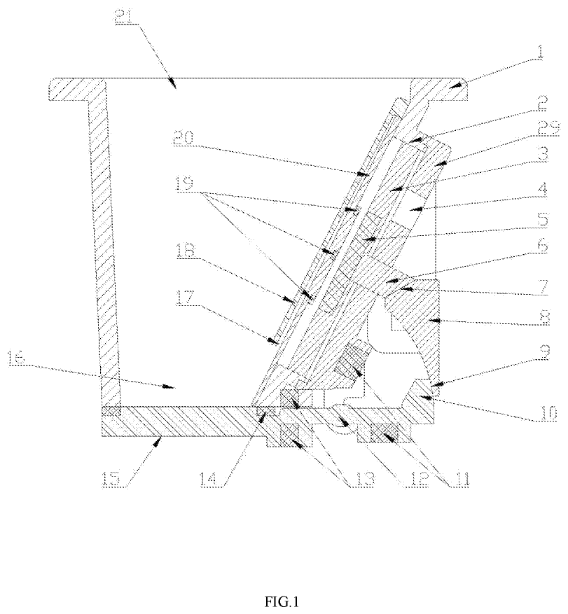

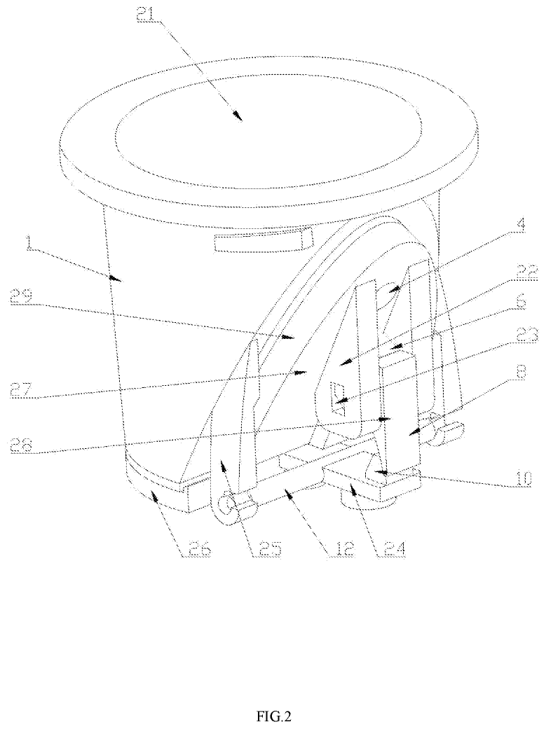

As show in FIGS.1-2:

1.sleeve; 2. groove; 3. pressure conductor; 4. pressure hole; 5. magnet block; 6. push rod; 7. bevel; 8. vertical movement rod; 9. Arc surface; 10. lock; 11. repulsion core set; 12. shaft; 13. Attraction magnetic core set; 14. sealing ring; 15. Open-close valve plate; 16. drain; 17. gap; 18. pressure-bearing plate; 19. magnetic point; 20. pressure conducting membrane; 21. intake; 22. support arm; 23. vertical guide groove; 24. lever; 25. support rod; 26. main body; 27. Negative pressure valve; 28. Locking mechanism; 29. multifunctional cover

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology:

### DETAILED DESCRIPTION OF EMBODIMENTS

A sealing device having positive and negative pressure resistant water seal protection function, comprising a sleeve 1; the lower end of the sleeve 1 is rotatably connected with an Open-close valve plate 15, comprising a negative pressure valve 27 is provided on the side of the sleeve 1; the negative pressure valve 27 including a groove 2 and a multi-functional cover 29; the structure of the groove 2 is bevel 7; a pressure conducting membrane 20 is provided on the inclined surface of the groove 2, facing the inner side of the sleeve 1; the groove 2 is provided with a pressure conductor 3 corresponding to the pressure conducting membrane 20; the push rod 6 of the pressure conductor 3 passes through the multifunctional cover 29 which is matched with the groove 2; the push rod 6 cooperates with the open-close valve plate 15 through a locking mechanism 28; the multifunctional cover 29 is provided with a pressure hole 4 connected to the drain line.

In an embodiment, the surface of the opening of the groove 2 is inclined and arranged in the sleeve 1; wherein the upper end of the opening surface of the groove 2 is located at the upper port edge of the sleeve 1; wherein the lower end of the opening surface of the groove 2 is located in the middle of the lower port of the sleeve 1; the upper port of the sleeve 1 is an intake 21; wherein the area enclosed by the surface lower end of the opening of the groove 2 and the lower port of the sleeve 1 is the drain outlet.

Wherein the lower end surface of the sleeve 1 is provided with a sealing ring 14 that matches the upper surface of the open-close valve plate

Wherein a repulsion core set 11 and an attraction magnetic core set 13 are provided between the bottom of the groove 2, multifunctional cover 29 and the open-close valve plate 15; wherein when the open-close valve plate 15 rotates to the open position, the repulsion core set 11 approaches and generates repulsive force, and the attraction magnetic core set 13 moves away; when the Open-close valve plate 15 rotates to the closed position, the attraction magnetic core set 11 generates an attractive force while the repulsion core set 13 moves away.

Wherein both sides of the open-close valve plate 15 connect to the sleeve 1 via the shaft 12; wherein the attraction magnetic core set 13 is located on the side of the shaft 12 which is close to the drain 16 outlet; wherein the magnetic core set 11 is arranged on the side of the shaft 12 opposite the drain outlet 16.

In another embodiment, a pressure-bearing plate 18 is placed at the opening of the groove 2 facing towards the inner side of the sleeve 1; a gap 17 is provided between the pressure-bearing plate 18 and the pressure conducting membrane 20 to connect the internal space of the sleeve 1.

In a third embodiment, mutually repelling magnets are positioned between the pressure conducting membrane 20 and the pressure conductor 3.

Wherein the pressure conductor 3 is provided with a magnetic block 5; wherein magnetic points 19 are dispersedly provided on the pressure conducting membrane. The magnetic forces of the magnetic point 19 and the magnetic block 5 repel each other.

In a fourth embodiment, a locking mechanism 28 including a vertical movement rod 8; the upper end of the vertical movement rod 8 cooperates with the push rod 6 of the pressure conductor through the bevel 7; the end of the open-close valve plate 15 is provided with a lock 10; the lock 10 and the vertical movement rod 8 cooperate through the arc surface 9.

Wherein the multifunctional cover 29 is provided with a support arm 22; the support arm 22 is provided with a vertical guide groove 23; wherein guide blocks are provided on both sides of the vertical movement rod 8 to match the vertical guide groove 23.

Wherein the open-close valve 15 plate including the drain 16 and a main body 26; a lever 24 is provided on one side of the main body 26; there are rotating shafts 12 on both sides of the lever 24; wherein a support rod 25 is provided outside the sleeve 1; and the lower end of the support rod 25 matches the rotating shaft 24 of the lever 12.

Wherein the lock 10 is provided at the end of the lever 24.

As shown in FIG.1, when in use, sleeve 1 can be directly connected to the sewer line or can be connected to the sewer line through a water sealing mechanism. When there is a negative pressure in the drainage line, the inside of groove 2 is connected to the drainage pipeline, and the inside of groove 2 also forms Negative pressure, because there is a gap 17 between the pressure conducting membrane 20 and the pressure-bearing plate 18, and the gap 17 is connected to the indoor space outside the sewer line. Under the action of atmospheric pressure, the pressure conducting membrane 20 is deformed under pressure. When the negative pressure is large, the pressure conducting membrane 20 is in contact with the pressure conductor 3, forcing the pressure conducting membrane 20 to move in the groove 2; when the negative pressure is small, the magnetic point 19 of the pressure conducting membrane 20 and the magnet block 5 are still at a certain distance. Pressure can be generated on the pressure conductor 3. Pressure conductor 3 moves in groove 2 under the action of the pressure conductor film 20. The push rod 6 of the pressure conductor 3 moves obliquely downward, and the pressure conductor 3 moves vertically. The bevel 7 of vertical movement rod 8 cooperates, and the guide blocks on both sides of the vertical movement rod 8 slide in the vertical guide groove 23, so that the vertical movement rod 8 can only move downward. The lower end of the vertical movement rod 8 is connected with the end of the Open-close valve plate 15 The lock 10 at the bottom is in contact and gives a clockwise pressure to the lock 10; At the same time, the attraction magnetic core set 13 of the Open-close valve plate 15 is in a close state at this time, and also provides a clockwise pressure for the Open-close valve plate 15. force, so that the Open-close valve plate 15 remains closed, atmospheric pressure cannot enter the drainage pipeline from the drain 16, and the water seal is protected.

When drainage is required, water flows into the sleeve 1 through the water intake 21 at the upper end. The pressure-bearing plate 18 prevents the water from impacting the pressure conducting membrane 20. As the water flow decreases, it hits the main body 26 of the Open-close valve plate 15. The closing force of the Open-close valve plate 15, which is formed by the attraction magnetic core set 13, is much greater than the suction force. The vertical movement rod 8 and the lock 10 work together through the arc surface 9, allowing the Open-close valve plate 15 to smoothly rotate around the shaft 12 and open without jamming. The Negative pressure valve 27 is tilted to ensure that the internal drainage space of the sleeve 1 is large enough to quickly drain water. Once drainage is complete, the repulsive force between the Open-close valve plate 15 and the Negative pressure valve 27, generated by the repulsion core set 11, ensures that the Open-close valve plate 15 returns to the state of closing the drain 16.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

1. A sealing device having positive and negative pressure resistant water seal protection function, comprising a sleeve; the lower end of the sleeve is rotatably connected with an Open-close valve plate, comprising a negative pressure valve is provided on the side of the sleeve; the negative pressure valve including a groove and a multi-functional cover; the structure of the groove is bevel; a pressure conducting membrane is provided on the inclined surface of the groove, facing the inner side of the groove; the groove is provided with a pressure conductor corresponding to the pressure conducting membrane; the push rod of the pressure conductor passes through the multifunctional cover which is matched with the groove; the push rod cooperates with the open-close valve plate through a locking mechanism; the multifunctional cover is provided with a pressure hole connected to the drain line.

2. The sealing device having positive and negative pressure resistant water seal protection function of claim 1, comprising a pressure-bearing plate is placed at the opening of the groove facing towards the inner side of the sleeve; a gap is provided between the pressure-bearing plate and the pressure conducting membrane to connect the internal space of the sleeve.

3. The sealing device having positive and negative pressure resistant water seal protection function of claim 1, comprising mutually repelling magnets are positioned between the pressure conducting membrane and the pressure conductor.

4. The sealing device having positive and negative pressure resistant water seal protection function of claim 3, comprising the pressure conductor is provided with a magnetic block; wherein magnetic points are dispersedly provided on the pressure conducting membrane. The magnetic forces of the magnetic point and the magnetic block repel each other.

5. The sealing device having positive and negative pressure resistant water seal protection function of claim 1, comprising the surface of the opening of the groove is inclined and arranged in the sleeve; wherein the upper end of the opening surface of the groove is located at the upper port edge of the sleeve; wherein the lower end of the opening surface of the groove is located in the middle of the lower port of the sleeve; the upper port of the sleeve is an intake; wherein the area enclosed by the surface lower end of the opening of the groove and the lower port of the sleeve is the drain outlet.

6. The sealing device having positive and negative pressure resistant water seal protection function of claim 5, comprising the lower end surface of the sleeve is provided with a sealing ring that matches the upper surface of the open-close valve plate.

7. The sealing device having positive and negative pressure resistant water seal protection function of claim 5, comprising a repulsion core set and an attraction magnetic core set are provided between the bottom of the groove, multifunctional cover and the open-close valve plate; wherein when the open-close valve plate rotates to the open position, the repulsion core set approaches and generates repulsive force, and the attraction magnetic core set moves away; when the Open-close valve plate rotates to the closed position, the attraction magnetic core set generates an attractive force while the repulsion core set moves away.

8. The sealing device having positive and negative pressure resistant water seal protection function of claim 7, comprising both sides of the open-close valve plate connect to the sleeve via the shaft; wherein the attraction magnetic core set is located on the side of the shaft which is close to the drain outlet; wherein the magnetic core set is arranged on the side of the shaft opposite the drain outlet.

9. The sealing device having positive and negative pressure resistant water seal protection function of claim 1, comprising a locking mechanism including a vertical movement rod; the upper end of the vertical movement rod cooperates with the push rod of the pressure conductor through the bevel; the end of the open-close valve plate is provided with a lock; the lock and the vertical movement rod cooperate through the arc surface.

10. The sealing device having positive and negative pressure resistant water seal protection function of claim 1, comprising the multifunctional cover is provided with a support arm; the support arm is provided with a vertical guide groove; wherein guide blocks are provided on both sides of the vertical movement rod to match the vertical guide groove; wherein the open-close valve plate including the drain and a main body; a lever is provided on one side of the main body; there are rotating shafts on both sides of the lever; wherein a support rod is provided outside the sleeve; and the lower end of the support rod matches the rotating shaft of the lever; wherein the lock is provided at the end of the lever.
